(19) United States
(12) Patent Application Publication
(10) Pub. No.: US 2003/0055713 A1
(43) Pub. Date: Mar. 20, 2003

(54) System and method for distributing and recording targeted information

(76) Inventors: Albert Gregory Pinto, Anaheim Hills, CA (US); Malachi Daniel Clark, Costa Mesa, CA (US)

Correspondence Address: STETINA BRUNDA GARRED & BRUCKER, 75 ENTERPRISE, SUITE 250, ALISO VIEJO, CA, 92656, US

(21) Appl. No.: 09/954,757

(22) Filed: Sep. 17, 2001

(51) Int. Cl. G06F 17/60

(52) U.S. Cl. 705/10

(57) ABSTRACT

The present invention provides a method and system for viewing and interacting with category specific data. The category specific data may be real estate data, travel data, data about independent artists, data of interest to children, auction data, personal advertisement data, puzzles and games, etc. The method comprises: creating a targeted community by registering the community members; creating an electronic card having information relating to the category specific data, the electronic card created using information received from one of the community members; storing the information from the electronic card in a category specific database; transmitting information from the category specific database to a community member in response to a display request from the community member; and storing a record of the transmitted information in a log for determining targeted demographic information. The log may also be used to determine potential commissions.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to electronic communications, and more particularly to a system and method for a group of people (community) to electronically trade information about a specific topic, for example, information relating to real estate, information relating to travel, information of interest to children, information relating to independent artists or personal advertisements.

With respect to the real estate industry, conventional techniques for purchasing a home utilize face-to-face meetings between a real estate agent and a client. The agent meets with the client to identify the type of home that the client is interested in, as well as information regarding the client's needs for schools, transportation, and other services. The real estate agent researches the areas that satisfy the client's requirements and homes within those areas that meet the client's specifications and price requirements. The real estate agent then typically brings the client to the homes selected by the real estate agent for viewing. If the client is interested in a particular home, the client may make an offer for the purchase of that home.

While there is typically no substitute for in-person communications and home viewings, it is frequently difficult to coordinate the viewings between schedules of the client, real estate agent, and the home owner. Additionally, the homes to be viewed may be remote from one another such that viewing maybe limited to a single home per day. Morever, additional information relating to the particular area in which a home is located, e.g., school information, crime statistics, noise, air quality and other information of potential interest is not commonly available for distribution to the client at the time of the viewing.

Accordingly, there exists a need to create a technique for supplementing face-to-face meetings and viewings to provide a client with a substantial body of information relating to homes that may reasonably be of interest to the client. By providing a client with such information a client may indicate a preliminary interest in particular properties which can then be viewed by the client. Moreover, by providing a client with such a body of preliminary information, administrative functions of the real estate agent may be simplified and recorded in a manner to mitigate potential future disputes respecting disclosure of information to the client and real estate commission related information identifying the homes presented to the client by a particular real estate agent. The disclosure related information may be presented in greater detail than may commonly occur by means of oral communications between the agent and client. For example, information relating to crime statistics may be provided by means of links to local police department websites where such information is tabulated and presented in objective form. Commission related records may also be more completely and objectively tabulated, mitigating the potential for disputes respecting further oral communications between the agent and the client. By providing a more efficient and more comprehensive presentation to the client, a real estate agent can provide high value service, particularly to clients whose time for face-to-face meetings and viewings is limited. By providing clear documentation relating to the presentation of such information, disputes respecting the substance of abbreviated oral communications is also mitigated.

The problems discussed above with respect to real estate are also relevant to other categories of information, for example, travel related services. Therefore, a need exists for an electronic mechanism for a group of people to exchange information. Preferably the information can be in a variety of formats, e.g., textual, graphical, audio, video. The system and method should be dedicated to information on a single topic. Interactions (e.g., information viewed by a particular user) should be logged.

### BRIEF SUMMARY OF THE INVENTION

The present invention provides a method and system for viewing and interacting with category specific data.

The method comprises: creating a targeted community by registering the community members; creating an electronic card having information relating to the category specific data, the electronic card created using information received from one of the community members; storing the information from the electronic card in a category specific database; transmitting information from the category specific database to a community member in response to a display request from the community member; and storing a record of the transmitted information in a log for determining targeted demographic information. The log may also be used to determine potential commissions.

Information may be transmitted to multiple members of the community. A list of cards to view may be provided to a community member.

Information from electronic cards can be stored on a removable medium, such as a compact disk.

The method may include displaying a communication interface for community members to interactively communicate. The communication interface may be a white board. The user interface may be implemented using a browser. Preferably, the browser is a category specific mini browser.

Information stored on the electronic cards can be video information.

The system for community members to exchange category specific information includes: an electronic card generator configured to generate a plurality of electronic cards having category specific information stored thereon; a registration module configured to register a plurality of users as members of the community; a database configured to store information identified on the electronic cards; a log configured to store information exchanges to determine targeted demographic information; and an external interface for transmitting messages between community members.

The category specific data may be real estate data. The electronic cards may include information about property or people, for example a real estate agent or a prospective buyer. The real estate agent may send a list of properties to a prospective buyer to view. The electronic cards may also include disclosure information, including neighborhood disclosure information. A confirmation may be required indicating that the user has viewed the disclosure information. An electronic white board may be used to host virtual open houses. Logging can be used to determine potential commissions.

The category specific data may be travel data. The electronic cards may include information about destinations or people, such as a travel agent. Logging can be used to determine potential commissions.

### BRIEF DESCRIPTION OF THE DRAWINGS

These as well as other features of the present invention will become more apparent upon reference to the drawings wherein:

FIG. 1 is a block diagram of an exemplary configuration of the present invention;

FIG. 2 is a block diagram of the major components stored in memory of the server shown in FIG. 1;

FIG. 3 is a flow diagram illustrating exemplary logic performed by the server of FIG. 1 for creating and operating an electronic community in accordance with the present invention;

FIG. 4 is a flow diagram illustrating exemplary logic for creating and editing electronic cards in accordance with the present invention;

FIG. 5 is a flow diagram illustrating exemplary logic for creating a new electronic card;

FIG. 6 is a flow diagram illustrating exemplary logic for generating an electronic card;

FIG. 7 is a flow diagram illustrating exemplary logic for editing an existing electronic card;

FIG. 8 is an exemplary user interface illustrating the major functions that can be invoked by a member of the community;

FIG. 9 is an exemplary user interface screen for creating/viewing/editing electronic cards in accordance with the present invention;

FIG. 10 is an exemplary user interface screen for creating a new electronic card; and

FIG. 11 is an exemplary user interface screen for editing an existing electronic card.

### DETAILED DESCRIPTION OF THE INVENTION

The present invention provides a mechanism for a user to become a member of an electronic community. Pertinent information about the community members is stored on electronic cards. For example, if the community is devoted to sports enthusiasts, independent musicians, independent artists, or entertainers, information may be stored on electronic trading cards. If the information is for business purposes, for example an electronic card file (e.g., an electronic Rolodex™) or a community of real estate brokers, information may be stored on electronic business cards. The electronic cards, whether for business or hobby, whether for creating a catalog or trading or collecting, may contain information in a variety of formats, for example, text, graphics, audio, video, or some combination thereof.

U.S. patent application Ser. No. 09/718,298 titled “Method and Apparatus for Distributing and Trading Electronic Trading Cards,” filed on Nov. 21, 2000, the entire contents of which are incorporated herein by reference, discloses a system and method of collecting and trading electronic trading cards. That patent application discloses a mechanism for readily obtaining detailed written and pictorial information regarding various subjects and personalities of interest to the user. The information includes not only that available on a particular electronic trading card (ETC), but also links to various web sites having additional information related to the same player or sport. As such, by means of the invention disclosed in U.S. patent application Ser. No. 09/718,298, an enthusiast can obtain an electronic portal to subject-related information related to a particular subject, personality, or sport. The enthusiast value of the invention is not limited to sports enthusiasts. For example, music fans may recognize the application of the invention disclosed in U.S. patent application Ser. No. 09/718,298 to provide collectable information respecting their favorite performers and car enthusiasts may recognize application of the invention disclosed in U.S. patent application Ser. No. 09/718,298 to provide collectable information regarding antique cars or the like. The class of enthusiast is, therefore, not limited to sports fans, and can be extended to virtually any class of enthusiasts, collector or other category of organized interest. For the collector, the invention disclosed in U.S. patent application Ser. No. 09/718,298 allows not only for the collection of statistical information respecting individual players, but also video information that may depict various highlights of that player's professional career, and personal comments. To preserve collector value the ETCs may be stored in electronic form to preserve their condition, limited in distribution by readily measurable techniques, and encrypted to deter reproduction or otherwise ensure authenticity.

The invention disclosed in U.S. patent application Ser. No. 09/718,298 is directed to known subject matter (e.g. personalities, vehicles, etc.) for which information is publicly available. The present invention expands the concept of electronic trading cards to that of individualized cards. As described in further detail later, an individual can create an electronic card including information about himself or herself. In general, the card will be about a specific topic, such as the business of the individual (e.g. real estate agent, travel agent, etc.) or a particular hobby or interest (e.g., sports league, independent artist, etc.). The individual becomes a member of an electronic community related to the topic of the electronic card (e.g. real estate community, independent artist community, etc.) in order to exchange information about the topic of interest with other members of the community. The community may also combine known personalities with individualized cards. For example, the community may be a sports or music community that includes electronic cards for individuals as well as electronic cards for known personalities.

The present invention provides many advantages for various applications. From the user's perspective, desired information about a specific area of interest can quickly be received without having to sort through irrelevant information. The user can add his or her own information to be shared with others. Information can be shared in various ways, for example via the Internet and/or via removable media, such as a compact disk. The information can also be in virtually any format, e.g., textual, graphical, audio, video, or some combination thereof. From a provider's standpoint, the present invention allows for highly targeted demographics, e.g., for advertising. A logging capability provides tracking capabilities that can be used for various purposes, for example, for determining commissions on real estate sales.

The present invention has many applications, including real estate, travel, electronic card file, independent artists, etc. A real estate application of the present invention is described next. Several other applications (e.g., travel) are described later. It will be appreciated that the present invention can be applied to applications other than those described herein.

In the context of an application related to the dissemination of information about real estate, a community can be created that includes one or more real estate agents or brokers, as well as potential buyers and/or sellers. In exemplary embodiments, real estate agents pay a fee to be community members and consumers (e.g., buyers/sellers/lessors/lessees of property) can become members for free. The fee may be a flat fee or variable (e.g., based on the number of physical cards that can be created for each electronic card). For example, for a given fee, an agent may be able to create thirty electronic cards and may be able to make 1000 physical copies of each card. In exemplary embodiments, multiple cards may be physically stored together. For example, the real estate agent could create one electronic card describing herself (e.g., the number of years with her current agency, the total number of years as an agent, the number of years working in a particular geographic location, her sales volume for a given period of time, etc.). The agent might create 29 cards devoted to current sales listings. The agent could then store all 30 cards on a single CD that can be distributed, for example, to potential buyers or to other agents.

The community can be a general community including real estate agents from multiple agencies or the community can be specific and include only one agent or only agents from one agency or one branch of any agency. In exemplary embodiments, a category specific browser, such as the one described in U.S. patent application Ser. No. 09/840,350 is used to display community information. The category specific browser can be customized. For example, the viewer may be in the shape of a house and may be branded with the name of a particular real estate agent or agency.

The community can include information about related services, such as mortgage lenders, home inspectors, contractors, landscapers, etc. The real estate community provides “one stop shopping” for real estate needs. In exemplary embodiments, the community members can view multiple listing service (MLS) information. For example, real estate agents may have full MLS access, whereas consumers may have limited MLS access, for example, consumers may have access to limited information using a pass code provided by a real estate agent. Such access is logged so that the agent providing the access may be entitled to a commission, a portion of a shared commission, or a flat amount of money (e.g., a kickback rather than a commission).

A person in the market to purchase or lease property can view properties, chat with real estate agents or other buyers about property in a general or about a specific property. The communication mechanisms of the present invention may include a chat function, message boards, and a white board that can be used for group chatting, for example, for having a virtual open house. In exemplary embodiments, the virtual open house allows an agent to display pictures on a white board. The open house may also include an audio narration. The agent can annotate the pictures. Some embodiments may also allow other community members to add annotations. In other embodiments, the open house may include video instead of or in addition to pictures. An open house may also include the display of textual information, e.g., the price of the property, the square footage of the property, etc. People can take a virtual tour of a property, as well as make comments or ask questions about the property.

Community members can communicate with other community members through a variety of communication mechanisms. For example, community members can communicate using a white board, via a community chat function or via instant messaging. Community members can also communicate via e-mail, for example, a notification about a virtual open house can be sent to community members via e-mail. Information can also be sent via e-mail to non-community members. The present invention can greatly reduce the time required for a potential buyer to actually view properties because the buyer can eliminate undesirable properties without having to waste the time to actually physically travel to the property to view the property.

In exemplary embodiments, a real estate agent will select several properties for a prospective buyer to view. The agent can then provide the list of properties to view. The prospective buyer can then view the information about the properties on the list provided by the real estate agent.

When a potential buyer views a property using the present invention, information, such as when the property was viewed and what prompted the buyer to view the property (e.g., an agent notified the buyer about the property) can be logged. This information can be used to determine who may be entitled to a commission if the buyer eventually purchases the property. The information can also be sent back to the agent. Thus, the agent can follow-up with the potential buyer. This facilitates targeted direct marketing by the agent to prospective buyers.

Because of the specific interest of the community, targeted advertising can be performed. For example, landscapers, home inspectors, mortgage, lenders, etc., can advertise using the present invention via various methods, for example, banner advertisements and/or e-mail advertisements. The advertising can be further targeted using various criteria, for example, geographic location of a property or the asking price of a property.

The present invention can also be used for disclosure purposes in real estate transactions. Information can be provided that is relevant to a particular property, for example information about local schools, crime statistics, noise (e.g., located near an airport), geological conditions (e.g., located on a flood plane), etc. In exemplary embodiments, this information is provided using links to other relevant websites. Disclosure information can be related to a particular property or to the neighborhood in which the property is located. The information viewed by a potential buyer can be logged. A confirmation feature can be included having the user indicate that disclosure information has been displayed.

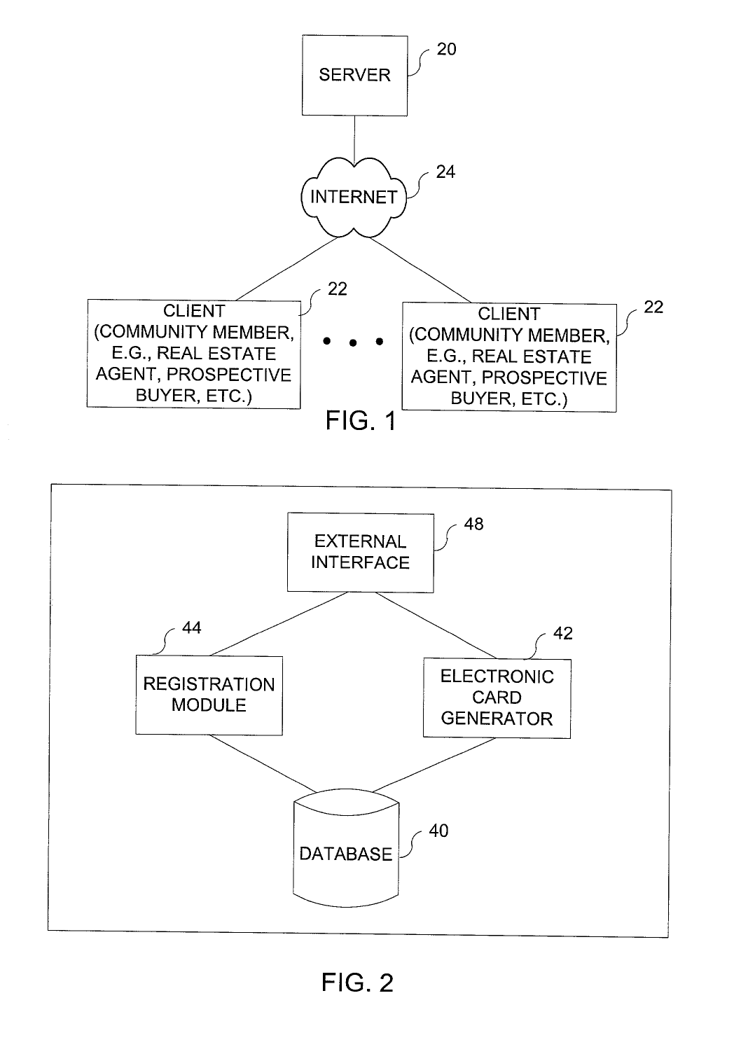

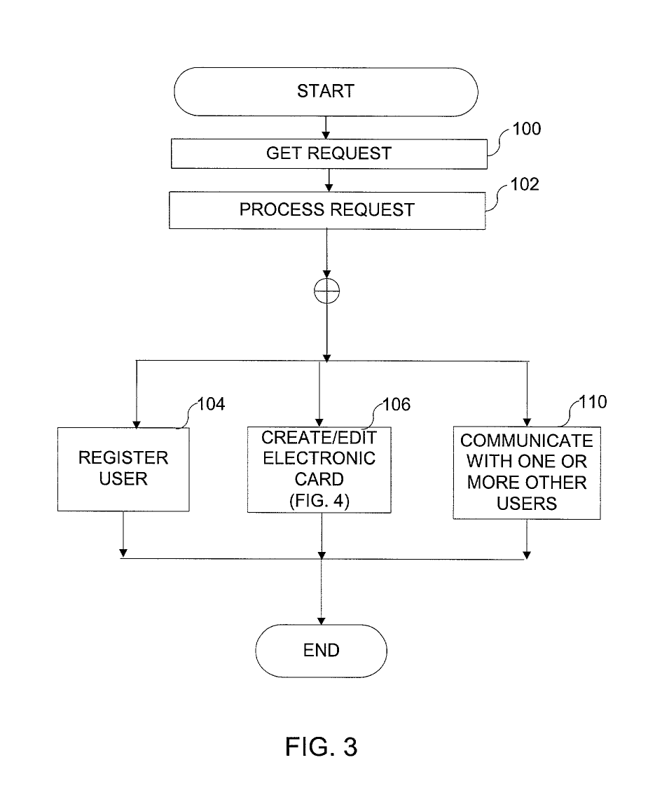

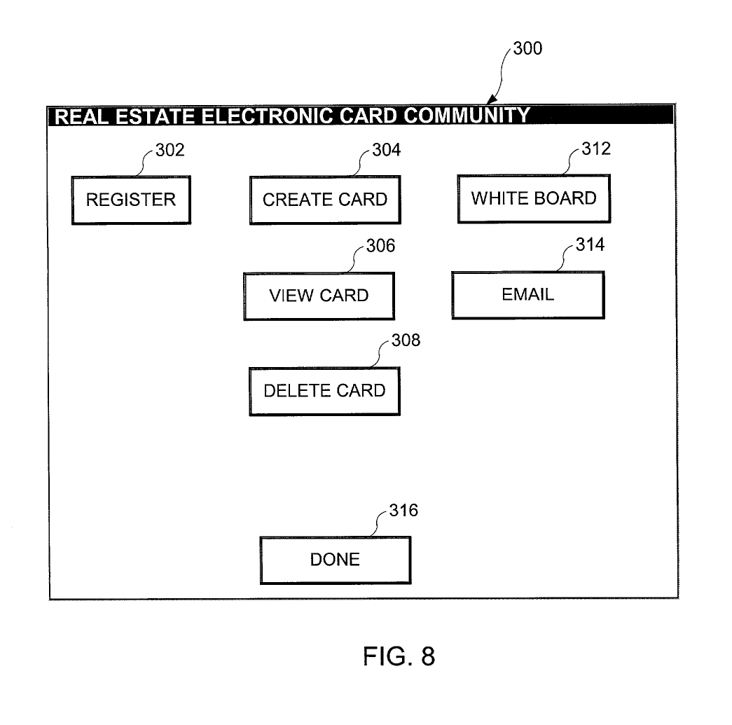

The present invention is described next in general terms which include references to an exemplary application for disseminating real estate related information. FIGS. 1-2 are block diagrams of the present invention illustrating major components included in any application of the present invention. It will be appreciated that various applications may include additional components. FIGS. 3-7 are flow diagrams illustrating exemplary logic of the present invention. As with the block diagrams of FIGS. 1-2, the flow diagrams shown in FIGS. 3-7 illustrate a general application of the system. The flow diagrams shown in FIGS. 3-7 are described in conjunction with exemplary user interface displays shown in FIGS. 8-11 which are based on an example having category specific information related to real estate.

Referring now to the drawings wherein the showings are for purposes of illustrating preferred embodiments of the present invention only, and not for purposes of limiting the same, FIG. 1 is a block diagram illustrating an exemplary implementation formed in accordance with the present invention. Clients (e.g., real estate agents, prospective buyers, etc.) 22 sharing a common interest form a community. The community members communicate via a server 20. The community members of the present invention may share any one of various common interests, e.g., real estate, travel, independent artists, etc. An example of a real estate community is described above. Several other examples of communities are described in further detail later. It will be appreciated that the present invention is not restricted to the communities described herein.

The server 20 and client computers 22 of the present invention can be any one of various types of conventional computers, having a processing unit, a memory (including a permanent storage device), and a communication interface, as well as other conventional computer components (e.g., input device, such as keyboard and mouse, output device, such as display). In exemplary embodiments, the communication interface allows the server 20 to communicate with the clients 22 over a network 24, such as the Internet.

FIG. 2 is a block diagram illustrating major components of the present invention that are stored in memory on the server 20.

A database 40, such as the one shown in FIG. 2, is used to store information. Exemplary data stored in the database 40 includes registration information for the members of the community. Exemplary embodiments may also include information about interactions of the community members (e.g., a log of user actions). A log of user interactions may be included in the database or may be implemented as a separate data store.

An electronic card generator 42 is used to create electronic cards. A function is provided that allows a community member 22 to enter information to create an individualized electronic card. For example, a real estate agent may create a card having information about a current property listing, and/or a card about herself (e.g., detailing her experience in the real estate profession). The information stored on the electronic card can include textual information, graphical information, audio information, video information, or some combination thereof.

Registration module 44 allows users of client computers 22 to register as members of the community. In exemplary embodiments, a category specific browser, such as the one disclosed in U.S. patent application Ser. No. 09/840,350, titled “Method and Apparatus for Viewing and Interacting with Category Specific Information,” filed on Apr. 23, 2001 the entire contents of which are incorporated herein by reference, is used for the community member to enter and view information relating to the community. For example, using the category specific mini browser, the user views a list of members and can view electronic cards (i.e., information about members) in the category specific mini browser. The user can communicate with other members of the community, for example using a white board. For example, a real estate agent can host an open house using a white board. All of the interactions (communications) occurring during the open house can be logged. The user can also communicate with non-members of the community, for example, by sending e-mail that includes some of the data from an electronic card. The recipient of the e-mail can then register to become a member of the community.

Electronic card generator 42 allows a community member 22 to create an electronic card. In exemplary embodiments, the member 22 can create multiple cards and edit existing cards.

An external interface 48 is used to transmit messages (including electronic cards) from the server 20 to community members 22 and to receive messages sent to the server 20 by community members 22. In exemplary embodiments, electronic cards can be traded directly between members. Preferably, the server 20 logs receipt of electronic cards by client computer 22 regardless of whether the electronic card was received from the server 20 or another client computer 22.

In exemplary embodiments, the member 22 can create a physical card, e.g., by storing the electronic card information on a writeable CD. The member can then give the physical card to other people. For example, a real estate agent can create physical cards to be given to clients. In various embodiments, the number of cards may be limited. For example, a real estate agent may be able to create a certain number of physical cards based upon a subscription fee paid by the agent.

It will be appreciated that in some embodiments there will be additional components not shown in FIG. 2. For example, a real estate community may have additional modules for virtual tours, virtual open houses, generating a property list for a prospective buyer, etc.

FIG. 3 is a flow diagram illustrating exemplary logic implemented for forming a community in accordance with the present invention. The logic of FIG. 3 moves from a start block to block 100 where a user interface is displayed. FIG. 8 is an exemplary user interface illustrating exemplary functions that can be performed using a method for distributing and recording targeted information formed in accordance with the present invention.

In the exemplary embodiment shown in FIG. 8, a category specific browser displays a user interface that allows a user to easily perform various functions within the fantasy sports card community. For example, as shown in the exemplary user interface of FIG. 8, the user can: register as a member of the community by pressing a Register button 302; create an electronic card pressing a Create Card button 304, view a card by pressing a View Card button 306; delete a card by pressing a Delete Card button 308; communicate with other users, for example via white board by pressing a White Board button 312 or an E-Mail button 314. It will be appreciated that additional functions may be available in various embodiments of the invention.

After the request is received, the logic moves to block 102 where the request is processed as described next. If the request is a registration request, the registration module 44 registers the user. See block 104. As described above, there may be different types of users. For example, a real estate community may require a member to enter the type of member (e.g., a prospective buyer). The registration information required may vary for different types of members. The registration information is stored in the database 40. If the request is to create or edit an electronic card, the logic moves to block 106 where an electronic card is created or edited.

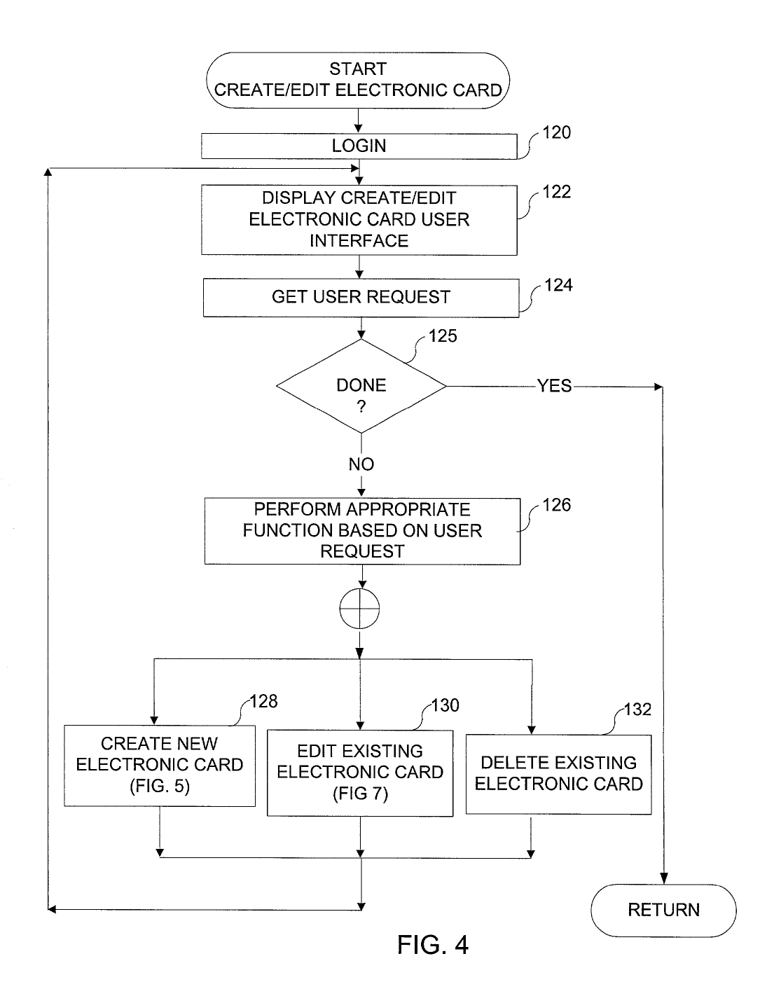

FIG. 4 is a flow diagram illustrating exemplary logic for creating or editing an electronic trading card in accordance with the present invention. The logic moves from a start block to block 120 where a user logs in. For example, the category specific mini browser for the community (e.g., real estate) may have a function for creating electronic cards. The user activates (i.e., executes) the category specific mini browser program and navigates (e.g., through menus and/or buttons) to create the electronic card function. In alternative embodiments, the user may navigate to a website and request a login by entering a user identification and password. A verification of the user identification/password is performed. If the information is valid, a secure login is performed. Upon a successful login, a user interface display provides the user with various available functions. See block 122.

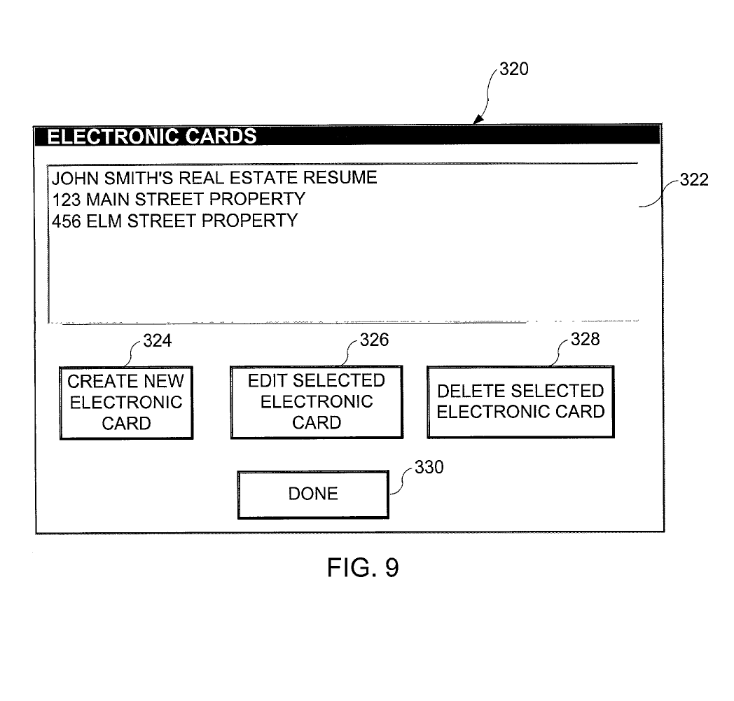

An exemplary user interface for creating/editing electronic cards 320 is shown in FIG. 9. The electronic trading user interface 320 may include a list of all existing electronic cards for the user 322. In the exemplary electronic card user interface 320 shown in FIG. 9, the user is a real estate agent who may opt to: create a new electronic card by pressing a Create New Card button 324, edit a selected electronic card by pressing an Edit Selected Card button 326 or delete a selected electronic card by pressing a Delete Selected Card button 328.

The logic of FIG. 4 proceeds to decision block 125 to determine if the user is done creating/editing/deleting electronic trading cards. For example, a user may press a Done button (330 in FIG. 9) to indicate completion. Alternatively, the user may indicate completion by navigating to a different website or a different function in the category specific browser. If the user has finished creating/editing/deleting electronic cards, the logic of FIG. 4 ends and processing returns to FIG. 3.

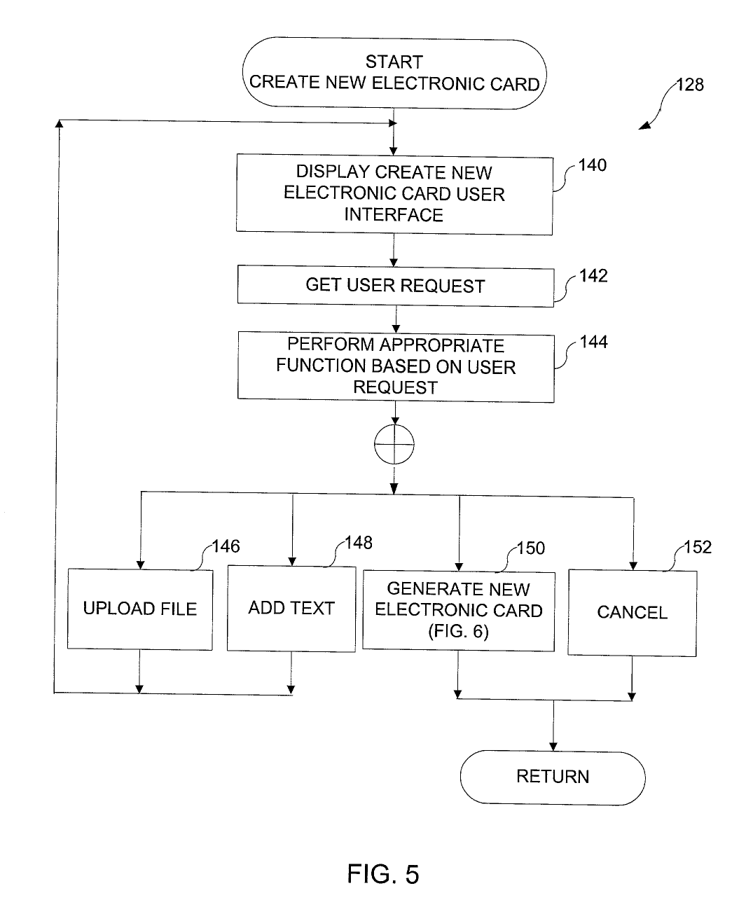

If, however, the user has not finished creating/editing/deleting individualized electronic cards, the logic moves to block 126 where the desired function is performed. If the desired function is to create a new electronic card, the logic moves to block 128 where a new electronic card is created as shown in FIG. 5 and described next.

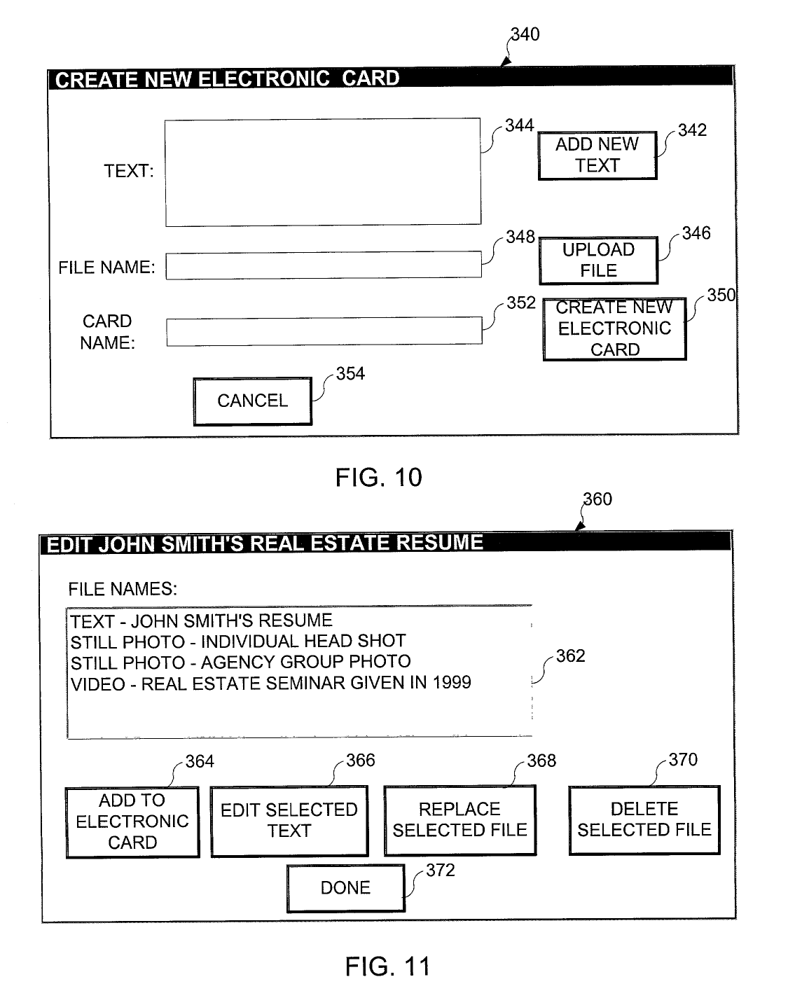

FIG. 5 is a flow diagram illustrating exemplary logic for creating a new electronic card. The logic moves from a start block to block 140 where a Create New Electronic Card user interface is displayed. FIG. 10 illustrates an exemplary user interface for creating a new electronic card.

In exemplary embodiments, such as the one shown in FIG. 10, the user can specify one or more files to be uploaded, for example by entering a filename in a filename field 348 and pressing an Upload File button 346. The file may be in various formats, e.g., text, graphics, audio, video. The user may also enter text in a text box 344 and have the text added to the electronic card by pressing an Add New Text button 342. When the user has entered all of the information, a new electronic card can be generated by the user specifying a name in a Card Name field 352 and pressing a Create New Card button 350. The user may also cancel the creation process by pressing a Cancel button 354.

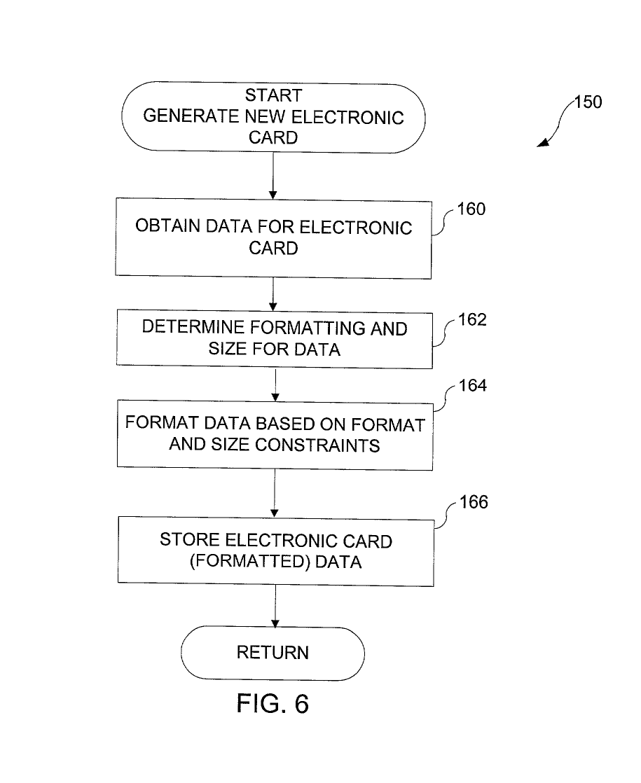

After the Create New Card user interface has been displayed, the logic of FIG. 5 moves to block 142 where a user request is received. Next, the logic proceeds to block 144 where the request is processed. If the request is to upload a file, the logic moves to block 146 where the file is uploaded. The logic then returns to block 142 to display the Create New Card user interface and retrieve another request to be processed. If the request is to add text, the logic moves to block 148 where the text is added. For example, the text is transmitted from the client computer 22 displaying the Create New Card user interface to a server 20 that creates and stores the electronic cards. The logic then returns to block 140 to display the Create New Card user interface and to get another request to process. If the request is to create a new electronic card, the logic moves to block 150 where an electronic card is generated as shown in FIG. 6 and described below. After the electronic card is generated (block 150) or if the request is a cancel request (block 152), the logic of FIG. 5 ends and processing returns to FIG. 4.

FIG. 6 illustrates exemplary logic for generating an electronic card. The logic of FIG. 6 moves from a start block to block 160 where data for the new card is obtained. In exemplary embodiments, the data is already at the server. For example, using a create new electronic card user interface such as that shown in FIG. 10, user specified text can be added and/or files can be uploaded. After specifying the desired text and/or files to upload, the user specifies a name to be used for the new electronic card. Alternatively, the data may reside at the client computer 22 until a request to generate the card is received. After the data for the electronic card has been obtained, the logic moves to block 162 where formatting and size is determined for the data. For example, the size of video to be used for a particular type of electronic card may be set to a different size than for a different electronic card. The format and size for a given type of data may vary based on the browser that is used to display the information. U.S. patent application Ser. No. 09/840,350 discloses a category specific mini browser suitable for viewing electronic cards created in accordance with the present invention. After the data is formatted, the logic moves to block 166 where the data for the new electronic trading card is stored. Various methods of storage may be employed, for example using a relational database. The logic of FIG. 6 then ends, and processing returns to FIG. 4.

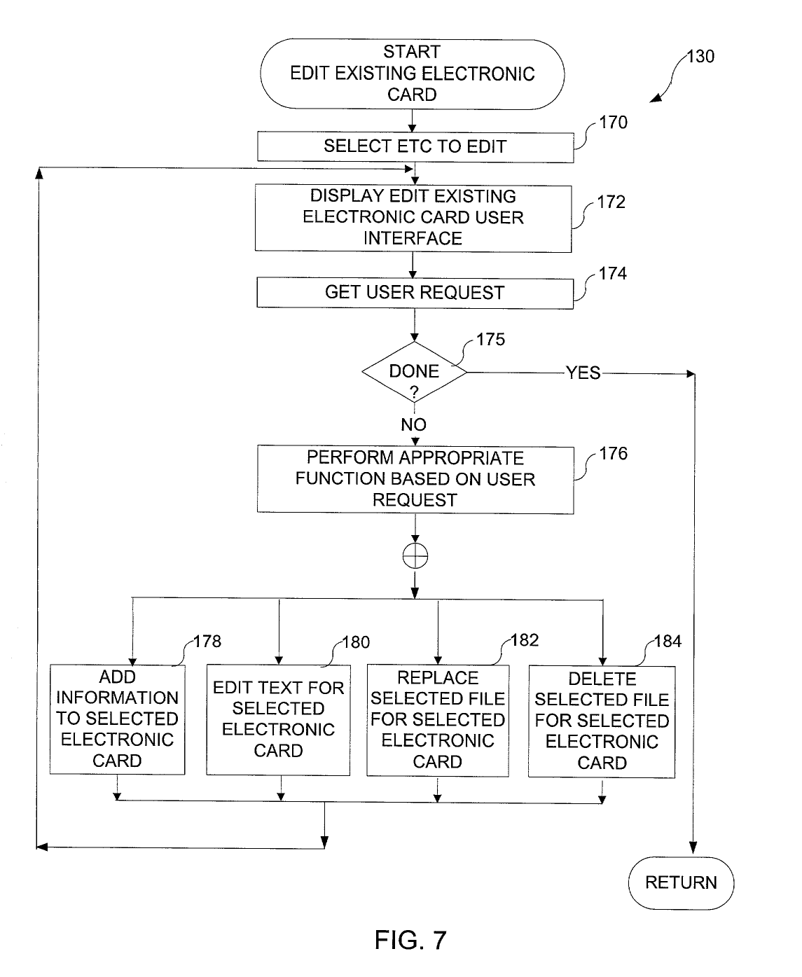

Returning to FIG. 4, if the user wishes to edit an existing electronic card, the logic moves to block 130 where the existing card is edited. FIG. 7 illustrates exemplary logic for editing an existing electronic card in accordance with the present invention.

The logic of FIG. 7 moves from a start block to block 170 where an existing electronic card is selected. Next, the logic moves to block 172 where a user interface displaying editing options is provided. In exemplary embodiments, new information can be uploaded to be added to the existing information and/or to replace existing information. Existing information may also be deleted. FIG. 11 illustrates an exemplary user interface for editing an electronic card in accordance with the present invention.

In the exemplary edit electronic card user interface 360 shown in FIG. 11, the user selected an electronic card(John Smith's Real Estate Résumé from FIG. 9) and selected an edit function (e.g., by pressing an Edit Selected Card button 326). The edit card user interface 360 shown in FIG. 11 includes a list of files 362 included in the electronic card being edited. The user can add information to the electronic card, for example by pressing an Add To Card button 364. In exemplary embodiments, the add to card function displays a user interface that allows the user to enter text and/or files to be uploaded. The user can also edit text previously entered by pressing an Edit Text button 366. In exemplary embodiments, selecting an edit text function, downloads the existing text to the user to be edited. The user may also replace (i.e., edit) selected files by pressing a Replace Selected File button 368. This causes the existing file to be deleted and replaced by a new file downloaded by the user. The user may also delete one or more files by pressing a Delete Selected File button 370.

The logic of FIG. 7 proceeds to block 174 where a user request is obtained. Next, the logic moves to decision block 175 to determine if editing the electronic card is complete. For example, the user indicates completion of editing by pressing a Done button (372 in FIG. 11). If the user has finished editing the selected electronic card (yes in decision block 175), the logic of FIG. 7 ends and processing returns to FIG. 4.

If, however, the user has not finished editing the electronic card, the logic moves to block 176 where an appropriate function is performed based on the user request. If the user opts to add information to an existing card, the logic moves to block 178 where information is added, for example by the client computer 22 uploading text and/or files to the server computer 20. If the user wishes to edit text, the logic moves to block 180 where text is edited for the selected card. For example, the current text for the electronic card is downloaded from the server 20 to the client computer 22 for editing. Once the text is edited, the revised text is uploaded from the client computer 22 to the server 20. If the user wishes to replace selected files for the selected electronic card, the logic moves to block 182 where selected files for the selected electronic card are replaced. If the user wishes to delete selected files, the logic moves to block 184 where selected files for the selected ETC are deleted. After the appropriate function is performed (e.g., adding information in block 178, editing text in block 180, replacing selected files in block 182, or deleting selected files in block 184), the logic returns to block 172 where the user interface is displayed and another user request is obtained and processed. The logic of blocks 172-184 is repeated until it is determined in decision block 175 that editing is done. When editing is done, the logic of FIG. 7 ends and processing returns to FIG. 4.

Returning to FIG. 4, if the request is to delete an existing electronic card, the logic moves to block 132 where an existing electronic card is deleted. Deleting an existing electronic card includes selecting an electronic card to delete and updating the database to delete the electronic card. In exemplary embodiments, the electronic card is marked as deleted but is not actually deleted from the database. Once an electronic card has been deleted, it does not show up in the list of existing electronic cards. After the requested function has been performed (e.g., creating a new electronic card in block 128, editing an existing electronic card in block 130, or deleting an existing electronic card in block 132), the logic returns to block 122 to display the Create/Edit Electronic Card user interface and to receive and process another user request. The logic of blocks 122-132 is repeated until there are no more user requests to process, for example due to the user navigating to another website. When there are no more requests to process, the logic of FIG. 4 ends and processing returns to FIG. 3.

Returning to FIG. 3, if the user wishes to communicate with another user, the logic moves to block 110 where the community member can communicate with another community member. In exemplary embodiments, members of the community can communicate using a white board, for example, for hosting an open house. In exemplary embodiments, a video clip may be played and users can write comments on the white board (e.g., annotate graphics). Members can also send messages via e-mail. In exemplary embodiments, e-mail messages may also be sent to users who are not members of the community.

As described above, the present invention is useful for disseminating and recording information about many other categories of information besides real estate. A few examples of categories of information that can be exchanged using the present invention are described below.

Another exemplary application of the present invention is information related to the travel industry. Community members include one or more travel agents, as well as travelers. The community may also include industries that are inter-related with the travel industry, for example, airlines, cruise lines, providers of traveler's checks, hotels and car rental agencies. As with the real estate industry, travelers can take virtual tours of various destinations. A white board may be used to show a vacation package to a group of prospective travelers. The virtual tours may include tourist attractions of a particular area, as well as a virtual tour of a hotel. The traveler can discuss a location prior to travel in order to determine whether to travel to the area. Travel agents can also provide educational information, e.g., seminars about travel tips. Once a destination is selected, the traveler can plan an itinerary based on information obtained through the travel community. Travelers can also provide information about an area, for example, hotel reviews, restaurant reviews, etc. that can be used by other travelers.

Targeted advertising for a travel community can be provided by relevant advertisers, such as local hotels, restaurants, car rental agencies, etc. for a locale being displayed by a user. As with the real estate application, interactions within the community are logged. Thus, if a traveler viewed information about a particular hotel based on information provided by a travel agent, that information is logged. Thus, even if the traveler ultimately booked a stay in the hotel directly, or through another travel agent, the travel agent that initially provided information to the user might be entitled to commission by the hotel based on the referral even without the traveler having to notify the hotel about the referral.

A traveler could also create an electronic postcard. Thus, a traveler can share information, for example about a vacation, with other people. The electronic postcard could include textual information, graphical information (e.g., photographs), audio information, video information, or some combination thereof. The traveler could share the information with non-community members via e-mail. The traveler could also store the information on a writeable CD. Several electronic postcards could be combined to create an electronic photo album.

A travel agent can create an individualized electronic card using the present invention. The electronic card can include information about the travel agent (e.g., years of experience, areas of expertise, such as group travel, cruises, etc.). The travel agent can create physical cards which can be given to clients and potential clients. It will be appreciated that electronic cards can be created by other members of the travel community, e.g., an airline, a train company (e.g., Amtrak), a hotel, a car rental agency, etc. For example, a train company or an airline might have flight schedules or train schedules on the electronic card. The electronic card may also include promotional specials. If the promotional specials are time sensitive (e.g. expire), the electronic card may include a link to a website that includes current promotional specials.

The present invention can also be used for personal advertisements. Individuals can create a card about themselves having personal information, such as a physical description, hobbies, employment information, financial status, etc. The information can be textual, graphical, audio and/or video in format. The community allows members to provide information about themselves and view information about others.

The community can also be used to disseminate information about events, such as singles mixers or corporate networking events for a particular industry.

Members of the community can chat. If a member created an electronic card, other members would be able to retrieve the card of another member while chatting to him or her.

In exemplary embodiments, members can store non-shareable information, as well as shareable information. For example, a member could retrieve the electronic card of another member. The member that retrieved the card could then add notes to the electronic card that was retrieved. Preferably, information annotated to an individualized card created by a member is stored at the client computer 22 that added the notes and can only be transmitted to another user with an explicit request by the user that added the notes.

In exemplary embodiments, the personal advertising community allows for virtual dates. The white board displays representatives of the parties. The representatives of the parties may be graphical, e.g., an avatar with characteristics matching those of the parties. The display may include graphics representing various locations, e.g., a restaurant, a bar, etc. The parties can then chat as they move the avatars on the display. Various embodiments may include virtual parties, as well as virtual dates. A virtual party is similar to a virtual date, but there are more people. Smaller groups could break off and go into a private chat room.

In exemplary embodiments an ignore feature blocks receipt of messages from specified users. Thus, if a member does not want to communicate with another member, the member indicates that communications from a specified member should be ignored.

In exemplary embodiments, entire chat sessions can be saved. The sessions can then be replayed later upon user request. In exemplary embodiments a user can add notes or comments to a stored chat session. Preferably, such notes or comments are stored on the client computer 22 and are not transmitted without a specific request from the member that added the notes.

In exemplary embodiments, files (e.g., graphics) can be displayed on the white board during a chat session. For example, a user can post a picture of himself or herself during a chat session.

The present invention can be used by entertainers, such as independent musicians or actors. The member can create an electronic card that may include a demonstration of the artist's work. The community not only allows fans to view (hear) the work, but also allows agents, producers, etc. to view (hear) the work. This provides a mechanism for producers and agents to scout talent quickly, easily, cheaply and hassle-free. This is beneficial to both the artists and the agents/producers. The artists work can be viewed at the request of a community member. Additionally, the artist can use various mechanisms (e.g., e-mail) to make others aware of the information available about the artist. Likewise, an agent can notify members of the community that they are searching for talent. For example, an agent looking for country artists can view the electronic cards of various members. Additionally, the agent can send e-mail or post messages that he is seeking country artists.

Applications in the independent artist field may include, for example, people in the adult entertainment field, for example, porn stars and porn film makers. In an adult entertainment community, a tipping system might be built in so that a viewer pays a fee for viewing an electronic card and the owner/creator of the card receives a fee. In exemplary embodiments, the server provider keeps a cut of the fee. Alternatively, a flat subscription fee (e.g., a monthly subscription fee) could be charged to members for unlimited viewing of electronic cards. As with the other communities, white boards could be used for chatting. Statistics can be kept to track the number of times each electronic card is viewed. Users could view statistics to determine the most viewed cards.

The present invention can also be used to implement online games and puzzles. For example, clues for a certain puzzle could be distributed at a certain time each day or week. The distribution could be limited so that only the first 10,000 (or 5,000, or 1,000, or 200, etc.) people requesting a clue could receive the clue. Members who could not receive a clue could try to get the clue from other community members, for example, by trading it for another clue. Prizes could be awarded based on the first to solve the puzzle or randomly selected from all members solving prior to a specified time or randomly selected from the first 100 (or some other number) to solve the puzzle correctly, etc.

Puzzles may be related to a particular topic, e.g., sports, travel, etc. Topically related puzzles could be part of another community (e.g., a travel community).

Puzzles could be various types of puzzles, for example, quizzes, scavenger hunts, jumble puzzles, mysteries, etc. Puzzles within a given contest may vary among members. For example, different members may have to find different items for a scavenger hunt. Members could trade items with other members.

Contests could vary in complexity based on prizes and/or the target age of the contestants. In exemplary embodiments, contests require a fee from member participants.

Prizes could be cash, merchandise, scholarships, etc.

The community could include entertainment games (e.g., bridge, hearts, cribbage, etc.), instead of or in addition to puzzles. Avatars can be used to display an online game. Members playing the game can chat while playing the game.

The present invention can also be used for online auctions. The online auctions can be real time. An item and description are displayed on a white board. An auctioneer requests an opening bid; members can bid.

In exemplary embodiments, the owner of an item can deny bids. For example, if the owner of the item knows that the member has not paid for items in the past, the owner of the item can refuse to sell to that particular bidder. The community may include records of items bought and payment status for each member.

Members can chat during an auction. This allows bidders to ask questions about an item, e.g., the size and color of the item.

In exemplary embodiments the seller could use a web cam to provide additional pictures of an item if needed during the bidding process.

The auction community could include other types of auctions in addition to or instead of realtime auctions, e.g., silent auctions or Dutch auctions.

The provider of an auction community could charge a subscription fee (for buyers and/or sellers) and/or a percentage of sales.

Specific communities (e.g., sports related communities) may have an auction function for items of interest (e.g., sports memorabilia) to members of the community.

The present invention can also be used to create communities for children. The community can be a generalized community for children wherein children can create cards including information about themselves related to a variety of topics, for example, interests (such as sports, video games, hobbies, etc), school issues, family issues, etc. Such a community may be limited to children within a particular age range. Communities for children may also be more specific, for example for little league players. In such a community, the members can create cards related to the particular topic of the community. For example, a little league player can create a card having a picture of himself in his little league uniform. The card may also have statistics for all of his little league activities. Little league video highlights can also be included on the card.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A real estate information exchange method for creating a targeted real estate community having a plurality of real estate community members, each of the real estate community members being able to exchange information with other real estate community members, the method comprising:
a) creating the targeted real estate community by registering the community members;
b) creating an electronic card having information relating to real estate stored thereon, the electronic card created using information received from a respective one of the community members;
c) storing the information from the electronic card in a real estate community database; and
d) transmitting information from the real estate community database to a respective real estate community member in response to a display request from the respective real estate community member.

2. The method of claim 1 further comprising storing a record of the transmitted information in a real estate community information exchange log, the real estate community information exchange log being operative to determine potential commission information and targeted demographic information.

3. The method of claim 1, wherein step (d) comprises transmitting information from the real estate community database to a plurality of real estate community members for hosting an open house by a real estate professional for a plurality of real estate community members.

4. The method of claim 1 further comprising providing an electronic card list to a respective community member prior to step (d), each of the electronic cards on the electronic card list having information about a respective property.

5. The method of claim 1, wherein step (a) comprises creating the plurality of electronic cards with at least one of the electronic cards having information relating to a property stored thereon.

6. The method of claim 5, wherein each of the electronic cards on the electronic card list includes disclosure information about the respective property.

7. The method of claim 6, wherein a confirmation agreement is transmitted to the respective real estate community member prior to transmitting the information from the real estate community database about the respective property.

8. The method of claim 6, wherein the disclosure information is neighborhood disclosure information.

9. The method of claim 1, wherein step (a) comprises creating the plurality of electronic cards with at least one of the electronic cards having information relating to a member of the real estate community stored thereon.

10. The method of claim 9, wherein step (a) comprises creating the plurality of electronic cards with at least one of the electronic cards having information relating to a member of the real estate community employed in a real estate related profession stored thereon.

11. The method of claim 9, wherein step (a) comprises creating the plurality of electronic cards with at least one of the electronic cards having information relating to a person interested in purchasing real estate stored thereon.

12. The method of claim 1 further comprising storing information from at least one electronic card on a removable medium.

13. The method of claim 1 further comprising the steps of:
e) displaying a communication interface on a first member computer to allow a first real estate community member to interactively communicate with at least one other real estate community member;
f) accepting information from the first real estate community member via the communication interface; and
g) forwarding the information from the first real estate community member to the at least one other real estate community member.

14. The method of claim 13, wherein step (f) comprises displaying a white board communication interface on a first member computer to allow a first real estate community member to interactively communicate with at least one other real estate community member.

15. The method of claim 13, wherein steps (f)-(h) are implemented through the use of a browser.

16. The method of claim 15, wherein step (f)-(h) are implemented through the use of a category specific mini browser.

17. The method of claim 1, wherein information stored on the electronic card is video information.

18. A real estate information exchange system for creating a real estate community having a plurality of real estate community members, each of the community members being able to communicate with other real estate community members, the system comprising:
a) an electronic card generator configured to generate a plurality of electronic cards, each of the electronic cards having real estate information provided by a respective community member stored thereon;
b) a registration module configured to register a plurality of users, each of the users being a member of the real estate community;
c) a real estate card database configured to store information identified on the electronic cards; and
d) an external interface for transmitting messages to and receiving messages from the real estate community members.

19. The system of claim 18 further comprising a real estate community information exchange log configured to log information exchanges to determine potential commission information and targeted demographic information; and

20. A method of creating a virtual real estate clearing house for providing targeted real estate information to prospective buyers, the method comprising:
a) loading a plurality of home files into a customer-specific database, each home file including graphic and textual information specific to an individual home;
b) loading a plurality of community information links into the database, the links being selected from a group of educational, cultural and other demographic information specific to each home file loaded into the data base;
c) selectively allowing access to the database to specific potential customers; and
d) logging access to the database by the specific potential customers.

21. The method of claim 20 further comprising the step of loading service provider links into the database, the service provider links being a group operative to direct potential customers to websites operated by home repair service providers.

22. The method of claim 20 further comprising the step of loading service provider links into the database, the service provider links being a group operative to direct potential customers to websites operated by home repair product providers.

23. The method of claim 20 further comprising the step of storing a record of each home file that the potential customer views to determine potential commission information in the event that the potential customer purchases the home corresponding to the home file.

24. The method of claim 20, further comprising creating an electronic real estate brochure by storing at least one home file on a removable medium.

25. A method of recording each home that is identified, described and illustrated to a potential customer by a real estate agent, the method comprising:
a) creating a database of home files, each home file having text and pictorial information specific to a home available for purchase;
b) selectively grouping home files into a show file for access by a potential customer after the customer logs into the show file; and
c) creating a record of each home file that the customer views from the show file in order to evaluate potential real estate commissions due from the sale of viewing a home corresponding to the viewed home file.

26. A travel information exchange method for creating a targeted travel community having a plurality of travel community members, each of the travel community members being able to exchange information with other travel community members, the method comprising:
a) creating the targeted travel community by registering the community members;
b) creating an electronic card having information relating to travel stored thereon, the electronic card created using information received from a respective one of the community members;
c) storing the information from the electronic card in a travel community database; and
d) transmitting information from the travel community database to a respective travel community member in response to a display request from the respective travel community member.

27. The method of claim 26 further comprising storing a record of the transmitted information in a travel community information exchange log, the travel community information exchange log being operative to determine potential commission information and targeted demographic information.

28. The method of claim 26, wherein step (d) comprises transmitting information from the travel community database to a plurality of travel community members for hosting a travel seminar by a travel professional for a plurality of travel community members.

29. The method of claim 26 further comprising providing an electronic card list to a respective community member prior to step (d), each of the electronic cards on the electronic card list having information about a respective destination.

30. The method of claim 26, wherein step (a) comprises creating the plurality of electronic cards with at least one of the electronic cards having information relating to a travel destination stored thereon.

31. The method of claim 26, wherein step (a) comprises creating the plurality of electronic cards with at least one of the electronic cards having information relating to a member of the travel community stored thereon.

32. The method of claim 31, wherein step (a) comprises creating the plurality of electronic cards with at least one of the electronic cards having information relating to a member of the travel community employed in a travel related profession stored thereon.

33. The method of claim 31, wherein step (a) comprises creating the plurality of electronic cards with at least one of the electronic cards having information relating to a person interested in purchasing travel stored thereon.

34. The method of claim 26 further comprising storing information from at least one electronic card on a removable medium.

35. The method of claim 26 further comprising the steps of:
e) displaying a communication interface on a first member computer to allow a first travel community member to interactively communicate with at least one other travel community member;
f) accepting information from the first travel community member via the communication interface; and
g) forwarding the information from the first travel community member to the at least one other travel community member.

36. The method of claim 35, wherein step (f) comprises displaying a white board communication interface on a first member computer to allow a first travel community member to interactively communicate with at least one other travel community member.

37. The method of claim 35, wherein steps (f)-(h) are implemented through the use of a browser.

38. The method of claim 37, wherein step (f)-(h) are implemented through the use of a category specific mini browser.

39. The method of claim 26, wherein information stored on the electronic card is video information.

40. A travel information exchange system for creating a travel community having a plurality of travel community members, each of the community members being able to communicate with other travel community members, communications among the travel community members being logged to determine potential commission information and targeted demographic information, the system comprising:
a) an electronic card generator configured to generate a plurality of electronic cards, each of the electronic cards having travel information provided by a respective community member stored thereon;
b) a registration module configured to register a plurality of users, each of the users being a member of the travel community;
c) a travel card database configured to store information identified on the electronic cards;
d) a travel community information exchange log configured to log information exchanges to determine potential commission information and targeted demographic information; and
e) an external interface for transmitting messages to and receiving messages from the travel community members.
